(19) United States
(12) Patent Application Publication
(10) Pub. No.: US 2025/0251276 A1
(43) Pub. Date: Aug. 7, 2025

(54) LIGHT SENSING METHOD AND LIGHT SENSOR MODULE THEREOF

(71) Applicant: SENSORTEK TECHNOLOGY CORP., Hsinchu County (TW)

(72) Inventor: TSUNG-HUA Wu, Hsinchu County (TW)

(21) Appl. No.: 19/047,676

(22) Filed: Feb. 7, 2025

Related U.S. Application Data
(60) Provisional application No. 63/550,632, filed on Feb. 7, 2024.

(51) Int. Cl. G01J 1/16; G01J 1/02

(52) U.S. Cl. CPC G01J 1/16; G01J 1/0209; G01J 2001/1615

(57) ABSTRACT

The present application provides a light sensing method and a light sensor module thereof, wherein the light sensing method includes obtaining optical signal values respectively by sensing of a first photodetection element, a second photodetection element, and a third photodetection element, wherein the first photodetection element and the second photodetection element have different effective photosensitive wavelength ranges, and the third photodetection element is a full-absorption band photodetection element. Through this, operation results of the optical signal values may be used to identify types of light sources.

### FIELD OF THE INVENTION

The present application relates to a light sensing method and a light sensor module, particularly for sensing types of light sources.

### BACKGROUND OF THE INVENTION

Light sensors, realized through photodetection technology, are widely used in various applications. For example, ambient light sensors (ALS) are employed in electronic products to detect an intensity of an ambient light, which helps in adjusting the brightness of display screens of the electronic products, enhancing usage convenience, and extending battery life. In addition to detecting the intensity of the ambient light, in certain applications, the light sensors may also be used to identify types of light sources to adjust parameters such as backlight of a display panel, colors of a display screen, or a white balance of image capturing.

In existing technology, to identify the types of the light sources based on photodetection results, infrared photodetection results generally must be used for identifying. This is because the component of the infrared light contained in sunlight is higher than the component of the infrared light contained in most indoor light sources, thereby, the infrared photodetection results may be used alone or in conjunction with other types of photodetection results to distinguish between indoor and sunlight sources.

However, refer to FIG. 1, which is a schematic diagram of a light sensor receiving light for signal sensing. The light sensor typically includes a semiconductor substrate 91, an epitaxy layer 92, and an optical filter 93. When the normally incident first light ray L1 passes through the optical filter 93 and is incident on the epitaxy layer 92, the optical filter 93 may filter out light outside the target wavelength range of the first light ray L1, allowing the light sensor to detect light within a specific wavelength range (such as visible light, infrared light). Nevertheless, in nowadays, compact design of electronic devices and the miniaturization of semiconductor elements, unintended secondary light rays L2 or tertiary light rays L3 may easily form. Wherein, internal reflections within the casing may easily rise to the secondary light ray L2, while light penetration through the semiconductor substrate 91 may generate the tertiary light ray L3.

The second light ray L2 and the third light ray L3, without passing through filter 93, are incident on the epitaxy layer 92, causing the light sensor to detect light outside a target wavelength range thereof, a phenomenon hereinafter referred to as sidewall light leakage. Such sidewall light leakage makes it difficult for existing technology to distinguish between indoor light sources and sunlight based on the photodetection results, or may lead to temporary misjudgments, thus severely affecting the performance of the light sensor.

### SUMMARY OF THE INVENTION

An objective of the present application is to provide a light sensing method and its light sensor module, which utilize the operation results of optical signal values sensed by three sets of photodetection elements to distinguish types of light sources, thereby eliminating the need for results from the infrared light wavelength band to determine indoor versus sunlight sources. This effectively mitigates the effects of sidewall light leakage, thus achieving more accurate light source identification.

The present application pertains to a light sensing method, which involves obtaining optical signal values by using first, second, and third photodetection elements, wherein the first and second photodetection elements have different effective photosensitive wavelength ranges, and the third photodetection element is a full absorption band absorbing photodetection element. Furthermore, a processor subtracts the optical signal value of the third photodetection element from the optical signal value of the first photodetection element to generate a first operation result, and operates a ratio based on the first operation result and the optical signal value of the second photodetection element, to identify light source types.

The present application relates to a light sensor module, which comprises a light sensor and a processor. The light sensor comprises a first photodetection element, a second photodetection element, and a third photodetection element, each of which is used to sense and obtain an optical signal value, wherein the first and second photodetection elements have different effective photosensitive wavelength ranges, and the third photodetection element is a full absorption band photodetection element. The processor is coupled respectively to the first, second, and third photodetection elements to receive the optical signal values from these photodetection elements. In this arrangement, the processor subtracts the optical signal value of the third photodetection element from the optical signal value of the first photodetection element to generate a first operation result, and operates a ratio based on this first operation result and the optical signal value sensed by the second photodetection element, for identifying types of light sources.

### BRIEF DESCRIPTION OF DRAWINGS

FIG. 1: A schematic diagram of the photodetection element receiving light for signal sensing;

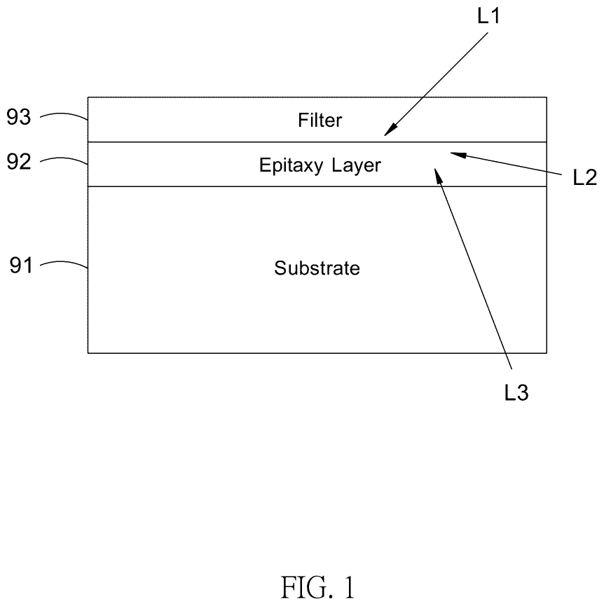

FIG. 2: A schematic structure diagram of the light sensor module according to a first embodiment of the light sensing method of the present application;

FIG. 3A: A diagram showing the photosensitive wavelength ranges of the first and second photodetection elements in the light sensor module of the present application;

FIG. 3B: A diagram showing the photosensitive wavelength range of the third photodetection element in the light sensor module according to the present application;

FIG. 4: A flowchart according to the first embodiment of the light sensing method of the present application;

FIG. 5: A diagram of a ratio generation according to the first embodiment of the light sensing method of the present application;

FIG. 6: A flowchart of a variant embodiment according to the first embodiment of the light sensing method of the present application;

FIG. 7: A schematic structure diagram of the photodetection element according to the second embodiment of the light sensing method of the present application;

FIG. 8A: A diagram showing the photosensitive wavelength range of the fourth photodetection element according to an embodiment of the light sensor module of the present application;

FIG. 8B: A diagram showing the photosensitive wavelength range of the fourth photodetection element according to another embodiment of the light sensor module of the present application;

FIG. 9: A flowchart according to a second embodiment of the light sensing method of the present application;

FIG. 10: A schematic diagram of another ratio generation according to the second embodiment of the light sensing method of the present application;

### DETAILED DESCRIPTION OF THE INVENTION

In order to provide the esteemed reviewers with a further understanding and recognition of the features and effects achieved by the present application, it is explained as follows with the aid of embodiments and accompanying descriptions:

In the specifications and subsequent claims, certain words are used for representing specific devices. A person having ordinary skill in the art should know that hardware manufacturers might use different nouns to call the same device. In the specifications and subsequent claims, the differences in names are not used for distinguishing devices. Instead, the differences in functions are the guidelines for distinguishing. In the whole specifications and subsequent claims, the word “comprising” is an open language and should be explained as “comprising but not limited to”. Besides, the word “coupled” includes any direct and indirect electrical connection. Thereby, if the description is that a first device is coupled to a second device, it means that the first device is connected electrically to the second device directly, or the first device is connected electrically to the second device via other device or connecting means indirectly.

Certain terms are used in the specification and claims to refer to specific elements; however, those skilled in the art should understand that manufacturers may use different terms to refer to the same element, and the specification and claims do not distinguish elements based on the difference in terms, but rather on the technical differences in the elements overall. The term “comprising” mentioned throughout the specification and claims is an open-ended term and should be interpreted as “including but not limited to.” Furthermore, the term “coupled” herein includes both direct and indirect means of connection. Therefore, if the text describes a first device coupled to a second device, it means that the first device may be directly connected to the second device, or indirectly connected to the second device through other devices or means of connection.

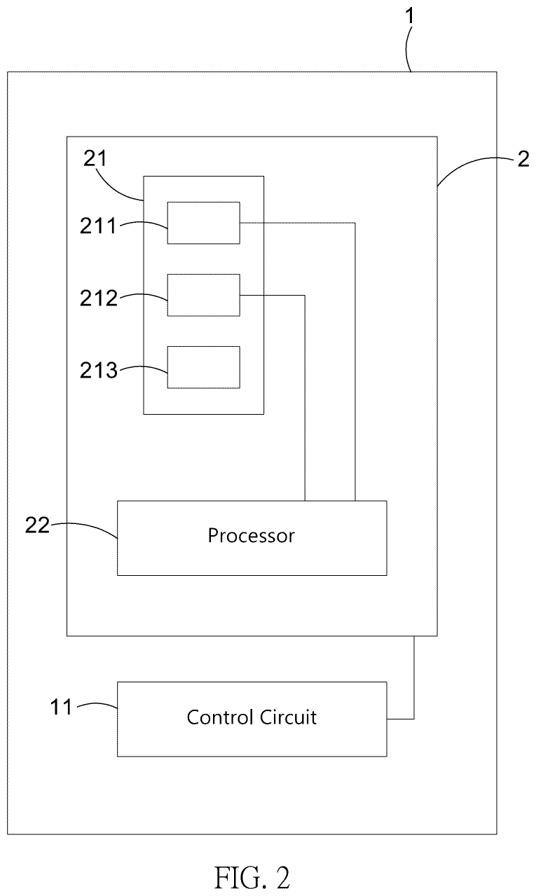

Please refer to FIG. 2, for the purpose of illustrating an embodiment of the light sensing method of the present application, an electronic device 1 is exemplified, wherein the electronic device 1 may include a light sensor module 2. The light sensor module 2 comprises a light sensor 21 and a processor 22, where the light sensor 21 includes a first photodetection element 211, a second photodetection element 212, and a third photodetection element 213, each of the first, second and third photodetection elements 211, 212, 213 is coupled to the processor 22 to transmit sensing signals to the processor 22 respectively.

The first and second photodetection elements 211, 212 may include photodiodes or other photodetection structures, and the first, second and third photodetection elements 211, 212, 213 have different photosensitive wavelength ranges. Specifically, by applying different coating layers on the first and second photodetection elements 211, 212, bandpass filter photodetection elements may be achieved to cause the first and second photodetection elements 211, 212 having different effective photosensitive wavelength ranges. The effective first photosensitive wavelength range of the first photodetection element 211 may be from 200 nm to 600 nm, preferably from 220 nm to 580 nm. The effective second photosensitive wavelength range of the second photodetection element 212 may be from 400 nm to 700 nm, preferably from 420 nm to 680 nm. The effective mentioned photosensitive wavelength range according to the present application refer to that light transmittances of the optical filters associated with the photodetection elements 211, 212, 213 are greater than 20%.

The third photodetection element 213 is a full absorption band photodetection element, that is, materials opaque to ultraviolet light, visible light, and infrared light may be added to be a full absorption band photodetection element, the materials may consist of a plurality of coating layers or could be a single material such as photoresist. The mentioned full absorption band photodetection element according to the present application refers to that a light transmittance of the optical filters associated with the photodetection element is less than 20% (or at least less than 10%) for all lights (or at least the aforementioned first and second photosensitive wavelength ranges and the infrared light wavelength band).

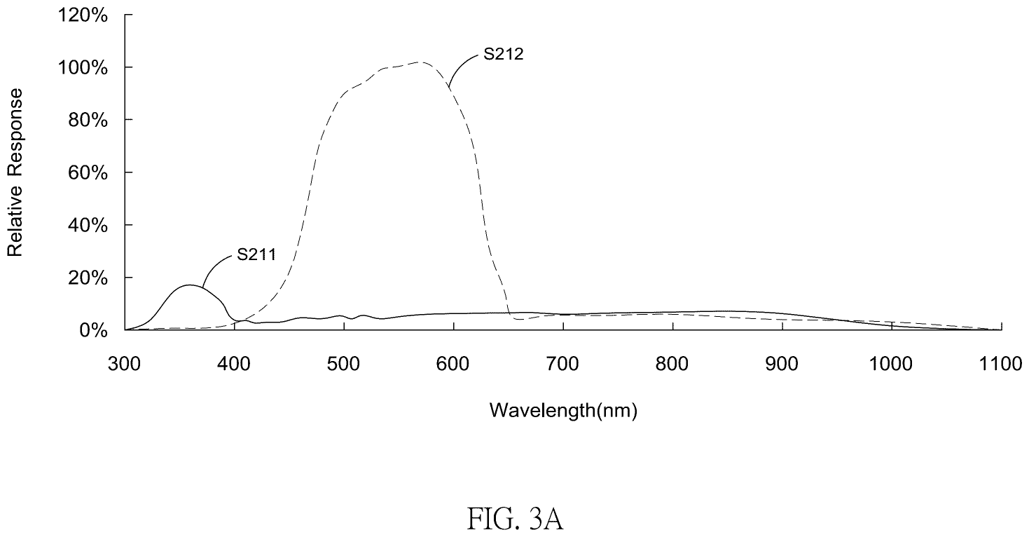

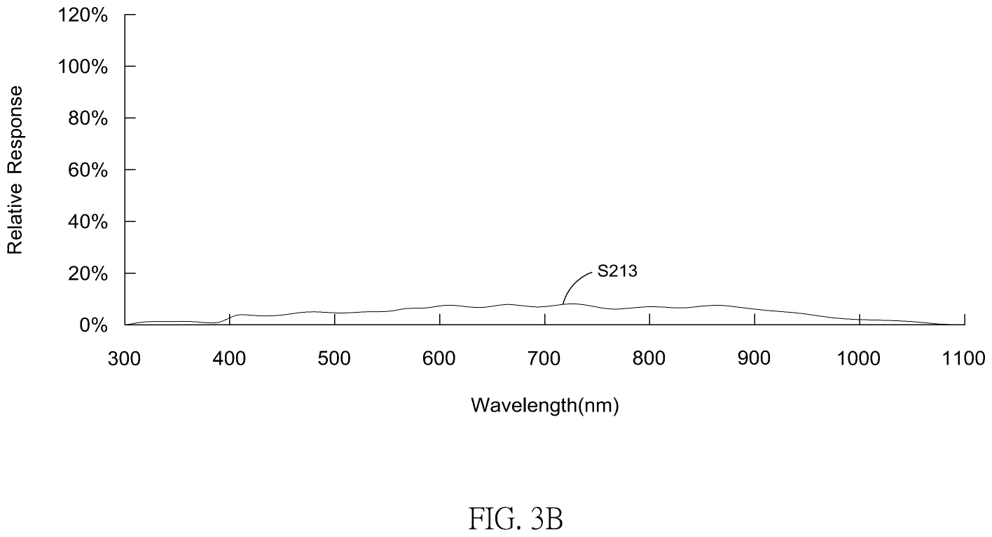

Please refer to FIG. 3A, which shows a schematic diagram of the photosensitive wavelength ranges S211 and S212 of the first photodetection element 211 and the second photodetection element 212. For illustration purposes, in an embodiment of the present application, the first photodetection element 211 is an ultraviolet light photodetection element with an effective photosensitive wavelength approximately 300 nm to 400 nm chosen from the aforementioned second photosensitive wavelength range, exemplified hereinafter; the second photodetection element 212 is a green light photodetection element with an effective photosensitive wavelength approximately 440 nm to 660 nm chosen from the aforementioned second photosensitive wavelength range, exemplified hereinafter.

Please refer to FIG. 3B, which is a schematic of the photosensitive wavelength range S213 of the third photodetection element 213. As the third photodetection element 213 is a full absorption band photodetection element, the third photodetection element 213 cannot effectively sense the light in the range of 300 nm˜1100 nm as shown in the figure.

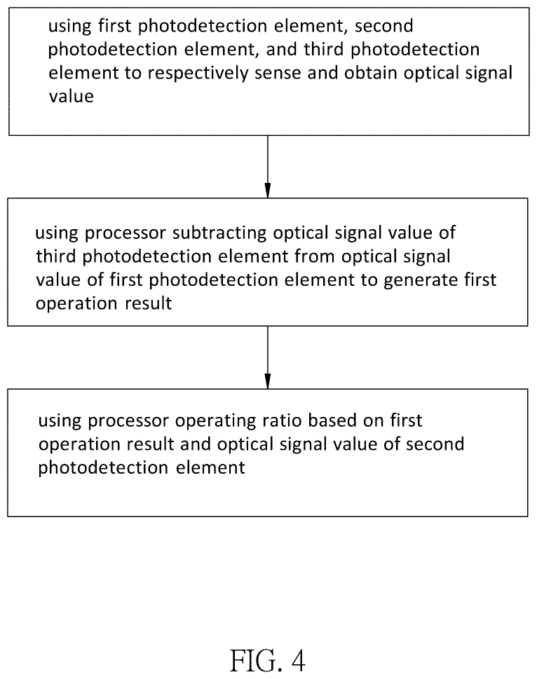

Please refer to FIG. 4, which illustrates the flowchart according to the first embodiment of the light sensing method of the present application. The following will explain how this light sensing method utilizes the light sensor module of the aforementioned embodiment for operation:

Firstly, using the first photodetection element 211, the second photodetection element 212, and the third photodetection element 213 to obtain an optical signal value respectively. As previously mentioned, the first photodetection element 211 and the second photodetection element 212 have different effective photosensitive wavelength ranges, and the third photodetection element 213 is a full absorption band photodetection element.

The processor 22 receives the optical signal values from the first photodetection element 211, the second photodetection element 212, and the third photodetection element 213, and at least subtracts the optical signal value of the third photodetection element 213 from the optical signal value of the first photodetection element 211 to generate a first operation result. Specifically, if the optical signal values of the first photodetection element 211, the second photodetection element 212, and the third photodetection element 213 are denoted as A, B, and C respectively, then the processor 22 may operate (A-αC) as the first operation result, where α is a first adjustment coefficient greater than 0.

The reason for generating the aforementioned first operation result in this embodiment of the present application is due to the characteristics of semiconductor epitaxy materials, as shown in FIG. 3A. When the first photosensitive wavelength range of the first photodetection element 211 approaches an ultraviolet light band, its sensitivity is lower, resulting in lower signal values. If sidewall light leakage of light occurs under these conditions, the optical signal value A obtained by the first photodetection element 211 will contain a larger proportion of sidewall light leakage component. Since the third photodetection element 213 is a full absorption band photodetection element, the optical signal value C detected by the third photodetection element 213 may be considered entirely as the sidewall light leakage component. Therefore, this embodiment of the present application eliminates the sidewall light leakage components in the optical signal value A of the first photodetection element 211 by subtracting the optical signal value αC of the third photodetection element 213.

As to the first adjustment coefficient α, it should be designed according to the characteristics of the light sensor module used by the user, and the first adjustment coefficient a may be generated by a circuit means in the light sensor 21, or by computational means within the processor 22. An objective of setting the first adjustment coefficient α is to match the ratio of the optical signal value A obtained by the first photodetection element 211 with the optical signal value C obtained by the third photodetection element 213, in order to eliminate the sidewall light leakage component in the optical signal value A of the first photodetection element 211 as much as possible.

Next, the processor 22 operates a ratio based on the first operation result and the optical signal value B obtained by the second photodetection element 212, to identify types of light sources, such as distinguishing between indoor light sources and sunlight. Specifically, the processor 22 may operate (A-αC)/B as the ratio and output it to the electronic device 1 for identifying the types of light sources.

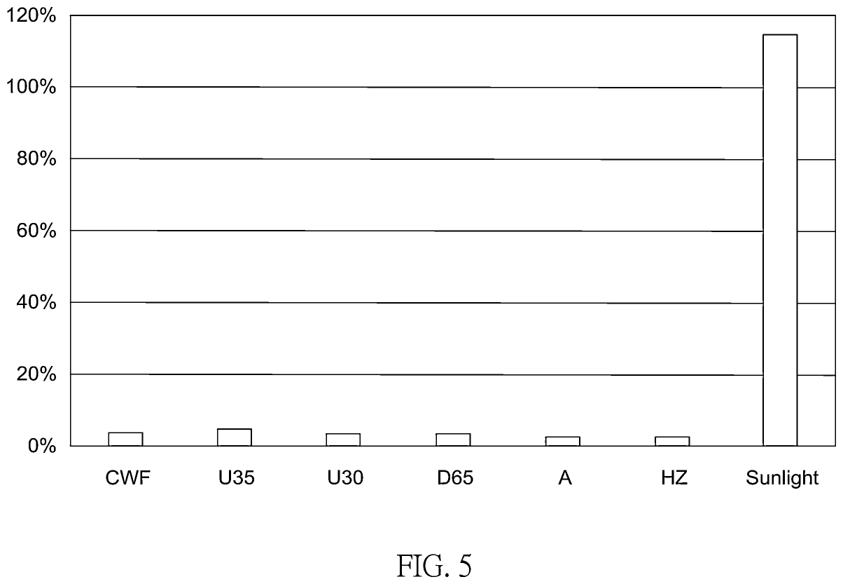

For example, the applicant, under conditions of sidewall light leakage, executes the first embodiment of the light sensing method for various light source conditions, resulting in a ratio diagram as shown in FIG. 5. Wherein, for various indoor light sources, such as incandescent light “A”, horizontal daylight “HZ”, simulated daylight “D65”, and various fluorescents “CWF, U30, U35”, the ratio is less than 20%. In contrast, for sunlight sources, the ratio exceeds 100%. Thus, after the electronic device 1 receives the ratio from the processor 22, the electronic device 1 may easily distinguish between indoor light sources and sunlight by setting thresholds and other well-known methods.

Wherein, the processor 22 may be coupled with a control circuit 11 of the electronic device 1, hereby, the control circuit 11 may adjust parameters, such as a backlight of a display panel, colors of a display screen, or a white balance of image capturing based on the type of light source. It is noted that the processor 22 may also be replaced by a computational circuit within the electronic device 1 in the light sensor module 2 according to some embodiments of the present application. In other words, the light sensor module 2 may merely perform photodetection, then transmit the sensing signal to the electronic device 1 for subsequent computation, without affecting the execution of the embodiments of the light sensing method of the present application.

Continued to above, through the first embodiment of the light sensing method of the present application, it may be effective in environments with sidewall light leakage, using a light sensor with three photodetection elements to generate results sufficient to distinguish between indoor light sources and sunlight. Notably, this first embodiment does not require the use of infrared light band sensing results to make the identification, and may accurately distinguish between indoor light sources and sunlight. This not only saves the cost of the light sensor 21 but also ensures that the overall method may exclude the effects of sidewall light leakage when executed. This is because, as aforementioned description, part of the sidewall light leakage is due to the third light ray L3 generated by light penetrating the semiconductor substrate 91. Regarding silicon substrates used commonly, light wavelengths close to infrared (e.g., wavelengths greater than 700 nm) have a higher light transmittance, thus avoiding the use of infrared light band sensing results may prevent the photodetection from the effects of sidewall light leakage.

The following describes various variant embodiments and implementations of the light sensing method according to the present application:

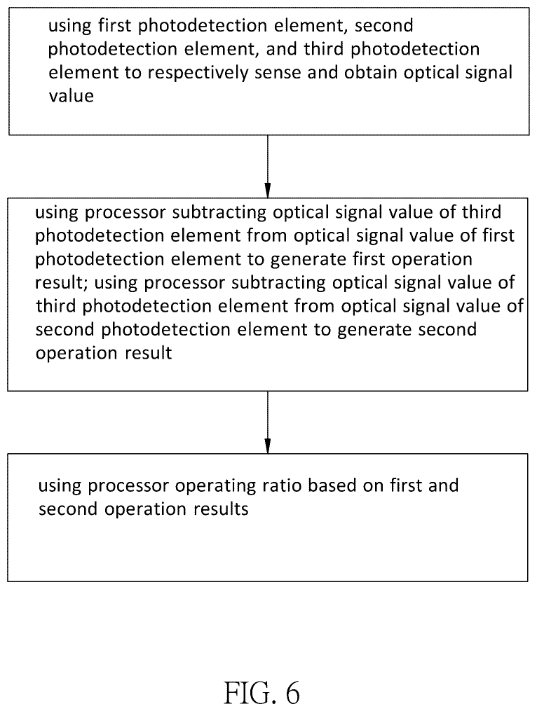

Refer to FIG. 6, although in the aforementioned first embodiment, the processor 22 only subtracts the optical signal value C of the third photodetection element 213 from the optical signal value A of the first photodetection element 211 to generate a first operation result. However, in another variant embodiment, if the user assesses that the optical signal value B of the second photodetection element 212 also contains a significant proportion of the sidewall light leakage component, the optical signal value C of the third photodetection element 213 may be subtracted from the optical signal value B of the second photodetection element 212 to generate a second operation result. Based on this first and second operation results, a ratio is operated to identify the types of the light sources, such as distinguishing between indoor light sources and sunlight. Specifically, the processor 22 may operate (B-βC) as the second operation result, where β is a second adjustment coefficient greater than 0. The processor 22 may operate (A-αC)/(B-βC) as the ratio, and output it to the electronic device 1 for identifying the types of light sources.

The second adjustment coefficient β should also be designed according to the characteristics of the light sensor module used by the user, and may be generated by the circuit means in the light sensor 21, or by the computational means in the processor 22. An objective of setting the second adjustment coefficient β is to match the ratio of the optical signal value B obtained by the second photodetection element 212 with the optical signal value C obtained by the third photodetection element 213, in order to eliminate the sidewall light leakage component in the optical signal value B of the second photodetection element 212 as much as possible. However, as shown in FIG. 3A, due to the characteristics of semiconductor epitaxy materials, when the second photosensitive wavelength range of the second photodetection element 212 approaches a visible light band, a sensitivity of the second photodetection element 212 will be higher than a sensitivity of the first photodetection element 211. Therefore, the optical signal value B obtained by the second photodetection element 212 usually contains a lower sidewall light leakage component, thus, it is preferable that the second adjustment coefficient β is set smaller than the first adjustment coefficient α.

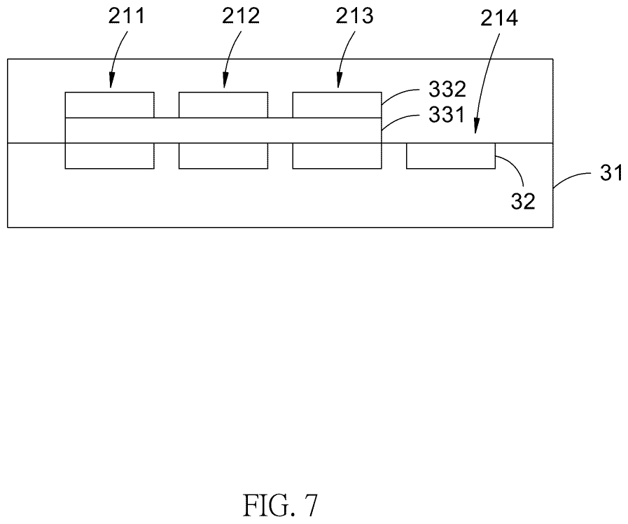

Although the previous embodiment employed a light sensor 21 comprising three photodetection elements 211, 212, 213, this embodiment of the present application does not limit the light sensor 21 to only using three photodetection elements. In the second embodiment of the present application, a light sensor 21 comprising a first photodetection element 211, a second photodetection element 212, a third photodetection element 213, and a fourth photodetection element 214 may also be selected. Please refer to FIG. 7, which is a schematic diagram of the light sensor 21 used in the second embodiment of the light sensing method of the present application. wherein the first photodetection element 211, the second photodetection element 212, the third photodetection element 213, and the fourth photodetection element 214 are all disposed on a semiconductor substrate 31, and the photodetection regions 32 of the first photodetection element 211, the second photodetection element 212, the third photodetection element 213, and the fourth photodetection element 214 are formed by using epitaxy layers on the semiconductor substrate 31.

The first photodetection element 211, the second photodetection element 212, and the third photodetection element 213 may be similar to the aforementioned embodiment, wherein the first photodetection element 211, the second photodetection element 212, and the third photodetection element 213 do not sense light in the infrared light wavelength band. Therefore, the light sensor 21 may be equipped with an infrared blocking layer 331 to prevent light in the infrared spectrum from entering the first photodetection element 211, the second photodetection element 212, and the third photodetection element 213, and different coating layers are set up as filters 332, corresponding to the first, second, and third photodetection elements 211, 212, 213 respectively, for different spectral bands of light.

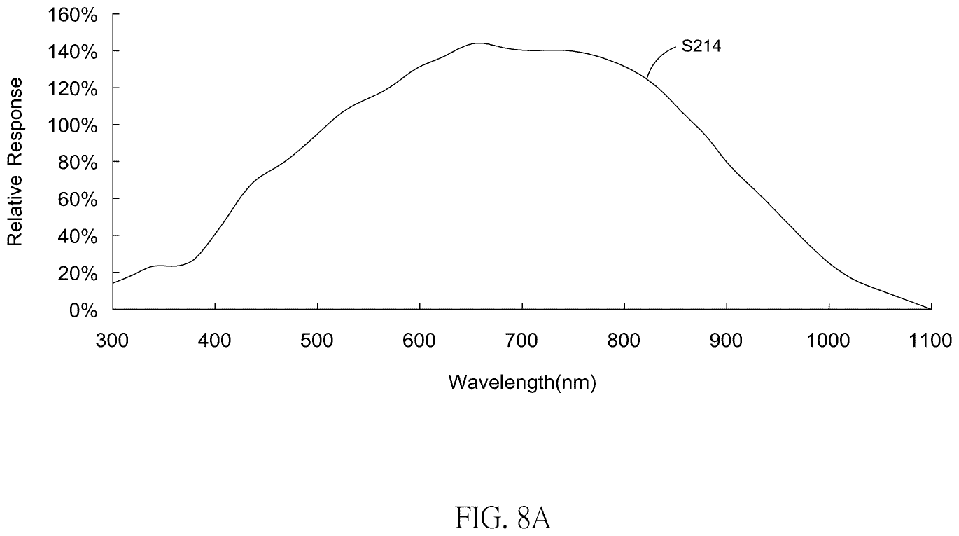

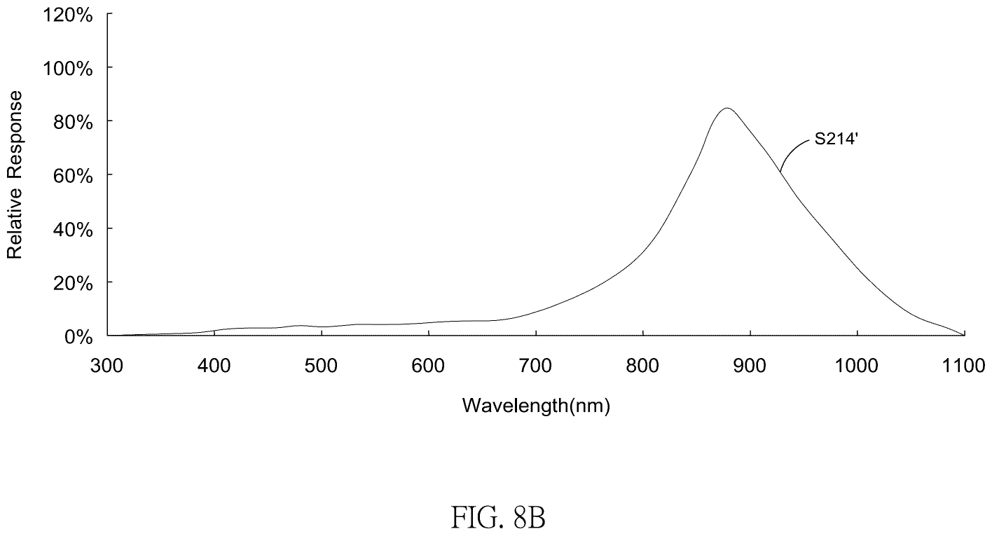

Please further refer to FIG. 8A, which shows the schematic diagram of the photosensitive wavelength range S214 of the fourth photodetection element 214. The fourth photodetection element 214 may be a full absorption band photodetection element, thus it does not require the aforementioned infrared blocking layer 331 and filter 332. Conversely, as shown in FIG. 8B, which is the schematic diagram of the photosensitive wavelength range S214′ of the fourth photodetection element 214 according to another embodiment of the present application, in this embodiment, wherein the fourth photodetection element 214 is a photodetection element for the infrared light band, the infrared blocking layer 331 still cannot be set up on the fourth photodetection element 214.

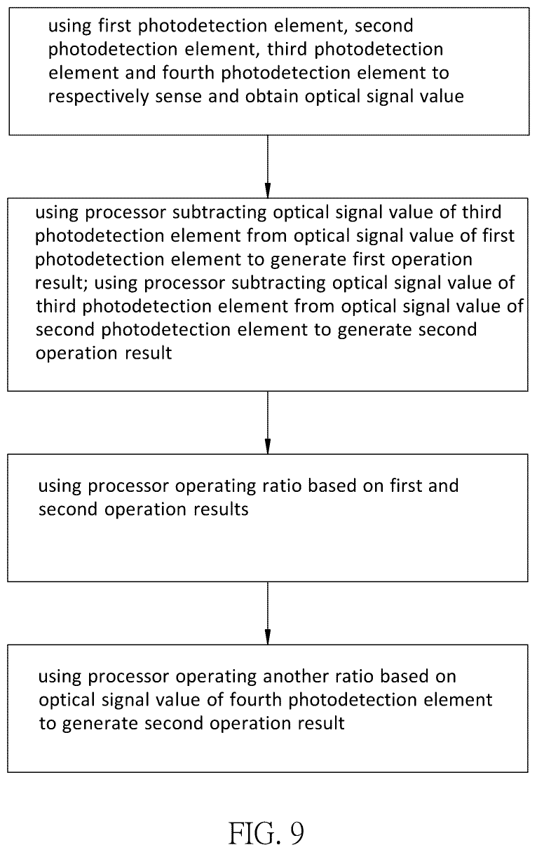

Please refer to FIG. 9, which shows the flowchart according to the second embodiment of the light sensing method of the present application, which is different from the first embodiment as the processor 22, in addition to generating a ratio based on the sensing results of the first photodetection element 211, the second photodetection element 212, and the third photodetection element 213, may optionally operate another ratio based on the optical signal value D obtained from the fourth photodetection element 214, to identify the types of the light sources, such as identifying the types of the indoor light sources.

Specifically, after electronic device 1 receives the ratio from processor 22, if the sensed object is determined to be an indoor light source, processor 22 may further provide another ratio to the electronic device 1. For example, another ratio may be generated based on the optical signal value D of the fourth photodetection element 214 and the optical signal value B of the second photodetection element 212. Moreover, the processor 22 may also subtract the optical signal value C of the third photodetection element 213 from the optical signal value D of the fourth photodetection element 214, and based on this, operate another ratio with the optical signal value B of the second photodetection element 212, and output it to electronic device 1 to distinguish the exact type of indoor light source. Specifically, processor 22 may operate (D-γC)/B as the other ratio, where y is a third adjustment coefficient greater than 0.

The third adjustment coefficient y should also be designed according to the characteristics of the light sensor module used by the user, and may be generated by a circuit means in the light sensor 21, or by computational means within the processor 22. The goal of setting the third adjustment coefficient y is to match the ratio of the optical signal value D sensed by the fourth photodetection element 214 to the optical signal value C sensed by the third photodetection element 213, in order to eliminate as much as possible the sidewall light leakage component in the optical signal value D of the fourth photodetection element 214.

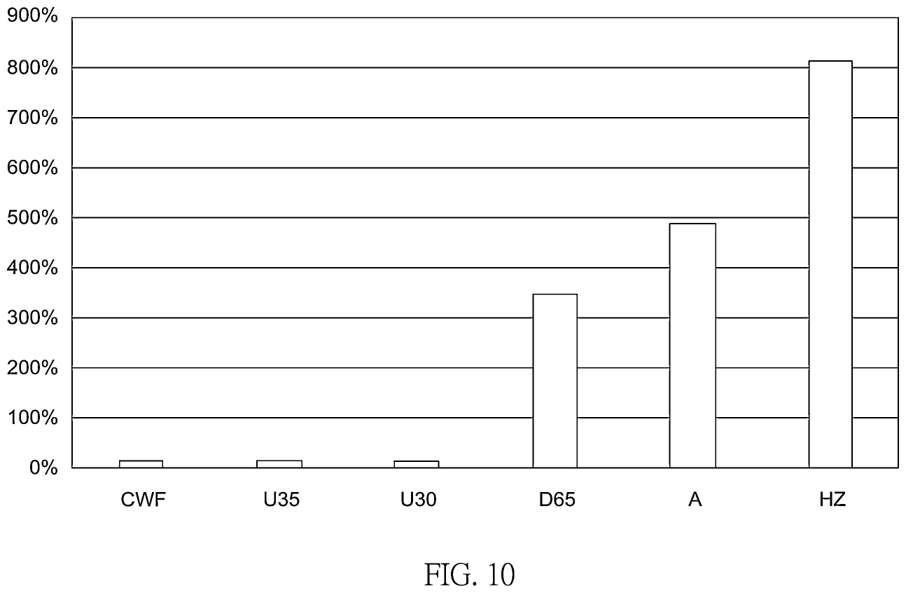

In the environments with sidewall light leakage, the applicant has executed the second embodiment of the above light sensing method under various light source conditions, resulting in another ratio diagram as shown in FIG. 10. Among these, for various indoor light sources such as incandescent light “A”, horizontal daylight “HZ”, simulated daylight “D65”, and various fluorescents “CWF, U30, U35”, there are significant differences in the other ratio. Therefore, after the electronic device 1 receives the other ratio from the processor 22, it may easily identify the exact types of these indoor light sources by setting thresholds and other well-known methods.

It should be noted that, through the second embodiment of the light sensing method of the present application, it is still effective in environments with sidewall light leakage, and it is possible to correctly distinguish between indoor light sources and sunlight without the need to use the sensing results of the infrared light spectrum. This not only saves the cost of the photodetection element but also ensures that the influence of sidewall light leakage may be excluded during the execution of the overall method. The second embodiment of the light sensing method of the present application involves, after an electronic device 1 determines the sensed object as an indoor light source, introducing the sensing results of the fourth photodetection element that covers the infrared light spectrum to assist in distinguishing the types of indoor light sources.

Sum up, the embodiments of the light sensing method of the present application and the light sensor module used utilize the optical signal values sensed by three sets of photodetection elements to distinguish types of light sources, without the need for sensing results from the infrared light spectrum to determine indoor and sunlight sources, compared to existing technologies that rely on sensing results from the infrared spectrum and are susceptible to the effects of sidewall light leakage on the performance of photodetection elements, the embodiments of the light sensing method and the light sensor module used in the present application may effectively eliminate the impact of sidewall light leakage, thereby achieving higher accuracy in determining light source types.

The above descriptions are merely preferred embodiments of the present application; any equivalent variations and modifications made within the scope of the patent application for the present application shall fall within the scope of the present application.

Therefore, the present application, being novel, progressive, and industrially applicable, undoubtedly meets the requirements for a patent application under our national patent law. Accordingly, the present application is filed in accordance with the law, earnestly praying for the patent grant at the earliest convenience.

However, the above descriptions are merely preferred embodiments of the present application and are not intended to limit the scope of the present application. Any equivalent modifications and variations in shape, structure, features, and spirit as described in the claims of the present application should be included within the scope of the present application.

1. A light sensing method, comprising:
using a first photodetection element, a second photodetection element, and a third photodetection element to respectively sense and obtain an optical signal value, wherein the first and second photodetection elements have different effective photosensitive wavelength ranges, and the third photodetection element is a full absorption band photodetection element;
using a processor subtracting the optical signal value of the third photodetection element from the optical signal value of the first photodetection element to generate a first operation result; and
using the processor operating a ratio based on the first operation result and the optical signal value of the second photodetection element, the ratio used for identifying types of light sources.

2. The light sensing method of claim 1, wherein an effective first photosensitive wavelength range of the first photodetection element is 200 nm to 600 nm, and an effective second photosensitive wavelength range of the second photodetection element is 400 nm to 700 nm.

3. The light sensing method of claim 2, wherein a light transmittance of the third photodetection element for the first photosensitive wavelength range, the second photosensitive wavelength range, and the infrared light band is less than 20%.

4. The light sensing method of claim 3, wherein the light transmittance of the third photodetection element for the first photosensitive wavelength range, the second photosensitive wavelength range, and the infrared light band is less than 10%.

5. The light sensing method of claim 1, wherein the optical signal values of the first, second, and third photodetection elements are A, B, and C, respectively, the processor operates (A-αC) as the first operation result, wherein a is α first adjustment coefficient greater than 0; the processor operates (A-αC)/B as the ratio.

6. The light sensing method of claim 1, further comprising:
using the processor subtracting the optical signal value of the third photodetection element from the optical signal value of the second photodetection element to generate a second operation result, and the processor generating the ratio based on the first and second operation results.

7. The light sensing method of claim 6, wherein the optical signal values of the first, second, and third photodetection elements are A, B, and C, respectively, the processor operates (A-αC) as the first operation result, where α is a first adjustment coefficient greater than 0; the processor operates (B-βC) as the second operation result, where β is a second adjustment coefficient greater than 0; the processor operates (A-αC)/(B-βC) as the ratio.

8. The light sensing method of claim 7, wherein the second adjustment coefficient β is less than the first adjustment coefficient α.

9. The light sensing method of claim 1, further comprising:
providing the ratio to an electronic device for distinguishing between indoor light sources and sunlight.

10. The light sensing method of claim 9, further comprising:
using a fourth photodetection element to sense and obtain an optical signal value; and
while the electronic device determines that a sensed object is an indoor light source, the processor operating another ratio based on the optical signal value of the fourth photodetection element, for determining a type of the indoor light source.

11. A light sensor module, comprising:
a light sensor, comprising a first photodetection element, a second photodetection element, and a third photodetection element, each of the first, second and third photodetection elements configured to sense and obtain an optical signal value, wherein the first and second photodetection elements have different effective photosensitive wavelength ranges, and the third photodetection element is a full absorption band photodetection element; and
a processor, coupled respectively to the first, second, and third photodetection elements, receiving the optical signal values from these elements;
wherein, the processor subtracts the optical signal value of the third photodetection element from the optical signal value of the first photodetection element to generate a first operation result, and operates a ratio to identify types of light sources based on this result and the optical signal value obtained from the second photodetection element.

12. The light sensor module of claim 11, wherein an effective first photosensitive wavelength range of the first photodetection element is 200 nm to 600 nm, and an effective second photosensitive wavelength range of the second photodetection element is 400 nm to 700 nm.

13. The light sensor module of claim 11, wherein a light transmittance of the third photodetection element for the first photosensitive wavelength range, the second photosensitive wavelength range, and the infrared light band is less than 20%.

14. The light sensor module of claim 13, wherein the light transmittance of the third photodetection element for the first photosensitive wavelength range, the second photosensitive wavelength range, and the infrared light band is less than 10%.

15. The light sensor module of claim 11, wherein the optical signal values of the first, second, and third photodetection elements are A, B, and C respectively, the processor operates (A-αC) as the first operation result, where α is a first adjustment coefficient greater than 0; the processor operates (A-αC)/B as the ratio.

16. The light sensor module of claim 11, wherein the processor subtracts the optical signal value of the third photodetection element from the optical signal value of the second photodetection element, generating a second operation result, and the processor operates the ratio based on the first and second operation results.

17. The light sensor module of claim 16, wherein the optical signal values of the first, second, and third photodetection elements are A, B, and C respectively, the processor operates (A-αC) as the first operation result, where α is a first adjustment coefficient greater than 0; the processor operates (B-βC) as the second operation result, where β is a second adjustment coefficient greater than 0; the processor operates (A-αC)/(B-βC) as the ratio.

18. The light sensor module of claim 17, wherein the second adjustment coefficient β is less than the first adjustment coefficient α.

19. The light sensor module of claim 11, wherein the processor is coupled to an electronic device, and outputs the ratio to the electronic device for distinguishing between indoor light sources and sunlight.

20. The light sensor module of claim 19, wherein the light sensor further includes a fourth photodetection element, which obtains an optical signal value for sensing, and when the electronic device determines the sensed object to be an indoor light source, the processor operates another ratio based on the optical signal value of the fourth photodetection element and outputs it to the electronic device to determine a type of the indoor light source.
